(19) United States
(12) Patent Application Publication
(10) Pub. No.: US 2020/0190390 A1
(43) Pub. Date: Jun. 18, 2020

(54) ADDITIVE TO FLEXIBILIZE EPOXY-BASED RESINS FOR USE IN OIL FIELD APPLICATIONS

(71) Applicant: Covestro LLC, Pittsburgh, PA (US)

(72) Inventors: David P. Zielinski, Cranberry, PA (US); Michael K. Jeffries, Follansbee, WV (US); Amy Maxin, McKees Rocks, PA (US)

(21) Appl. No.: 16/638,297

(22) PCT Filed: Aug. 1, 2018
(86) PCT No.: PCT/US2018/044783

§ 371 Date: Feb. 11, 2020

(30) Foreign Application Priority Data
Aug. 15, 2017 (US) 62545601

(51) Int. Cl. C09K 8/42; C08G 59/62; C08G 59/40; C08G 59/50; C09K 8/44

(52) U.S. Cl. CPC C09K 8/426; C08G 59/621; C09K 8/44; C08G 59/50; C08G 59/4028

(57) ABSTRACT

The present invention provides an oil and gas well treatment comprising (a) preparing a composition by mixing an epoxy-based resin, an alkylphenol-blocked isocyanate, and a polyamine, (b) introducing the composition into a wellbore, (c) reacting the composition to produce a solid product, wherein the solid product reduces or prevents ingress of formation water into the oil and gas well. The inventive methods may find use in a variety of applications where increased flexibility, resilience, and adhesion are desired or required

### CROSS REFERENCE TO RELATED APPLICATIONS

This application is a national stage application under 35 U.S.C. § 371 of PCT/US2018/044783 filed Aug. 1, 2018, which claims priority to U.S. Provisional Application Ser. No. 62/545,601 filed Aug. 15, 2017, both of which are incorporated herein by reference in their entireties.

### FIELD OF THE INVENTION

The present invention relates in general to epoxy-based resins and more specifically to flexibilized epoxy-based resins for use in a wide variety of technologies, including oil and gas field applications.

### BACKGROUND OF THE INVENTION

The recovery of resources, such as natural gas or oil, from an underground formation typically involves drilling a wellbore while circulating a drilling fluid, such as a water-based or oil-based drilling mud, within the wellbore. After the wellbore is drilled and completed, formation water may enter the well. A number of materials have been used in attempts to reduce or eliminate the ingress of formation water. Among the most common materials used for this purpose is cement.

Epoxy-based resins may be used instead of cement in well treatments such as plug and abandonment, loss circulation, and consolidation of sand and gravel, etc. However, epoxy-based resins have drawbacks because of their well-known tendency to initially expand (due to an exothermic reaction) followed by shrinkage or contraction during curing. This exothermic reaction may be dangerous in downhole environments as it may be difficult to control.

Shrinkage of sealing materials can cause problems in a downhole environment as it allows leakage around the seal made from a resin. Leakage in turn, may permit the ingress of water into the well from the surrounding formation. Such water creates an emulsion as it mixes with the oil, thus diluting the oil and resulting in high processing costs for separation, clarification and final disposal. If the areas of the well that allow water ingress could be effectively (permanently) sealed, the purity of the oil would be increased, thus reducing both the complexity and costs of production.

Further, because epoxy-based resins form brittle materials after cure, these materials lack flexibility which is desirable in the downhole environment to improve adhesion and resiliency providing better seals. These attributes can be especially important in dealing with pressure surges encountered during well completion activities.

Therefore, it would be desirable to provide improved epoxy-based resins and methods of use for a variety of applications, such as treating an oil and gas well to permanently seal areas of the well and reduce or prevent the ingress of water without the aforementioned drawbacks of current epoxy-based resins.

### SUMMARY OF THE INVENTION

Accordingly, the present invention provides such an improved epoxy-based resin containing an alkylphenol-blocked isocyanate for use in a variety of applications, such as treating an oil and gas well and other oil and gas field applications. The epoxy-based resin provides improved flexibility and a reduced exotherm during cure which will result in safer operations and produce a seal having better adhesion and resilience, which is particularly important in pressure surges such as those encountered during well completion activities.

In one aspect, the invention is directed to an oil and gas well treatment comprising (a) preparing a composition by mixing an epoxy-based resin, an alkylphenol-blocked isocyanate, and a polyamine, (b) introducing the composition into a wellbore, (c) reacting the composition to produce a solid product, wherein the solid product reduces or prevents ingress of formation water into the oil and gas well.

In another aspect, the invention is directed to an oil and gas well plug comprising an epoxy-based resin, an alkylphenol-blocked isocyanate, and a polyamine.

In still other aspects, the invention is directed to a method of treating an oil and gas well within an underground formation, comprising (a) preparing a composition by mixing an epoxy-based resin with an alkylphenol-blocked isocyanate and a polyamine, (b) introducing the composition into the well, (c) forcing the composition into pores of the formation, and (d) reacting the composition to form a solid product, wherein the solid product seals existing perforations and associated fractures of the formation to reduce or prevent the ingress of water into at least a portion of a wellbore or an oil and gas well within the formation.

In yet other aspects, the invention is directed to an oil and gas well containing a composition comprising an epoxy-based resin, an alkylphenol-blocked isocyanate, and a polyamine, wherein the composition solidifies within the oil and gas well to partially or completely prevent water ingress.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a), and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “various non-limiting embodiments,” “certain embodiments,” or the like, means that a particular feature or characteristic may be included in an embodiment. Thus, use of the phrase “in various non-limiting embodiments,” “in certain embodiments,” or the like, in this specification does not necessarily refer to a common embodiment, and may refer to different embodiments. Further, the particular features or characteristics may be combined in any suitable manner in one or more embodiments. Thus, the particular features or characteristics illustrated or described in connection with various or certain embodiments may be combined, in whole or in part, with the features or characteristics of one or more other embodiments without limitation. Such modifications and variations are intended to be included within the scope of the present specification.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As used herein, the term “polymer” encompasses prepolymers, oligomers and both homopolymers and copolymers; the prefix “poly” in this context referring to two or more, and the term “molecular weight”, when used in reference to a polymer, refers to the number average molecular weight, unless otherwise stated.

“Completed” or “completion” or “complete” means the process of making a well ready for production (or injection) and includes strengthening the well hole with casing, evaluating the pressure and temperature of the formation, and installing proper equipment to ensure an efficient flow of oil and gas out of the well.

As used herein, the phrase “oil and gas well” encompasses oil wells, gas wells and wells which produce both oil and gas. As used herein, the words “wellbore” and “borehole” mean a hole that is drilled in a geologic formation to aid in the exploration and recovery of oil and gas. A wellbore is the hole that forms the well. A wellbore may be encased by materials such as steel and cement, or may be uncased. The terms “wellbore” and “borehole” are used interchangeably herein.

In various embodiments, the invention is directed to an oil and gas well treatment comprising (a) preparing a composition by mixing an epoxy-based resin, an alkylphenol-blocked isocyanate, and a polyamine, (b) introducing the composition into a wellbore, (c) reacting the composition to produce a solid product, wherein the solid product reduces or prevents ingress of formation water into the oil and gas well.

In other embodiments, the invention is directed to an oil and gas well plug comprising an epoxy-based resin, an alkylphenol-blocked isocyanate, and a polyamine.

In certain embodiments, the invention is directed to a method of treating an oil and gas well within an underground formation, comprising (a) preparing a composition by mixing an epoxy-based resin with an alkylphenol-blocked isocyanate and a polyamine (b) introducing the composition into the well, (c) forcing the composition into pores of the formation, and (d) reacting the composition to form a solid product, wherein the solid product seals existing perforations and associated fractures of the formation to reduce or prevent the ingress of water into at least a portion of a wellbore or an oil and gas well within the formation.

In still other embodiments, the invention is directed to an oil and gas well containing a composition comprising an epoxy-based resin, an alkylphenol-blocked isocyanate, and a polyamine, wherein the composition solidifies within the oil and gas well to partially or completely prevent water ingress.

The compositions and methods of the invention may be useful in a wide variety of oil and gas field applications such as: plug and abandonment; reduction or prevention of water flooding; sand consolidation; bottom water and edge water control; drilling fluid loss control; drilling wellbore strengthening; horizontal drilling; high angle drilling wellbore treatment in bend areas of 60° or greater inclination; stacked pay zone plugging through straddle packer application; small fault sealing prior to acidizing or fracturing; injection well treatment for shut-off of weak or fractured layers; in a leaking annulus; deep well channel repair; and coating of corroded or otherwise damaged tubulars.

Thus, in various embodiments, the compositions and methods of the invention may be employed in plug and abandonment which is a gas tight solution prior to cementing plugging that prepares a well to be closed permanently after production operations have drained the well.

In certain embodiments, the compositions and methods of the invention may be employed in the reduction or prevention of water flooding, e.g., closing off of channels with potential for enhanced oil recovery (EOR) or tertiary recovery assist in shales.

In some embodiments, the compositions and methods of the invention may be employed in sand consolidation which is a way to control the undesirable production of sand from weak sandstone formations. Sand consolidation chemically binds the grains of sand while maintaining sufficient permeability to achieve viable production rates.

The compositions and methods of the invention may be employed, in various non-limiting embodiments, in bottom water and edge water control. As those skilled in the art are aware, petroleum reservoirs are often associated at the edges or at the bottom with water aquifers that support the reservoir pressure through water influx. When pressure drops in the petroleum reservoir, the water aquifer reacts to offset, or retard, this pressure decline by providing a source of water influx or encroachment.

In certain embodiments, the compositions and methods of the invention may be employed in drilling fluid loss control. Drilling fluid loss is the leakage of the liquid phase of the drilling fluid, slurry or treatment fluid containing solid particles into the underground formation. The resulting buildup of solid material may be undesirable.

In some embodiments, the compositions and methods of the invention may be employed in drilling wellbore strengthening in soft sediments. Mud loss is a potential problem during drilling operations. Induced loss occurs when the mud weight, required for well control and to maintain a stable wellbore, exceeds the fracture resistance of the formation. This may be a particular challenge in depleted reservoirs. There may be a drop in pore pressure as the reserves decline, which weakens hydrocarbon-bearing rocks, but neighboring low permeability rocks may maintain their pore pressure. This can make the drilling of certain depleted zones virtually impossible because the mud weight required to support the shale exceeds the fracture resistance of the sands and silts.

The compositions and methods of the invention may be employed, in various embodiments, in horizontal drilling which can be used in natural fracture shut-off. Horizontal drilling is a form of what is called “directional drilling,” and is where the departure of the wellbore from vertical exceeds about 80 degrees. Because a horizontal well typically penetrates a greater length of a given reservoir, it can offer significant production improvements over a vertical well.

In certain non-limiting embodiments, the compositions and methods of the invention may be employed in high angle drilling wellbore treatment in bend areas of 60° or greater inclination.

In some embodiments, the compositions and methods of the invention may be employed in stacked limestone and shale pay zone plugging through straddle packer application. Pay zones are rock formations in which oil and gas are found in exploitable quantities. A through-tubing permanent straddle packer assembly includes inflatable packers designed to isolate permanently a wellbore section. The packers are set one at a time or both in the same trip. These assemblies are run on threaded tubing, coiled tubing, or electric wireline. Packers differ from bridge plugs in that packers have an unrestricted internal diameter that allows for fluid flow from top to bottom or vice versa. Bridge plugs, on the other hand, are tools that, when set in a well, have no through-bore communication and prevent fluid flow in either direction.

In various embodiments, the compositions and methods of the invention may be employed in small fault sealing prior to acidizing or fracturing.

The compositions and methods of the invention may be employed, in certain embodiments, in injection well treatment for shut-off of weak or fractured layers.

In some non-limiting embodiments, the compositions and methods of the invention may be employed in leaking annulus sealer—down annulus injection of liquids with timed setup.

In various embodiments, the compositions and methods of the invention may be employed in deep well channel repair, as an alternative to cement squeezing. Cement squeezing refers to a technique to seal, with cement, a section of a wellbore where a leak or incursion of water or gas occurs; forcing to the bottom of the casing and up the annular space between the casing and the wall of the borehole to seal a formation or plug a leak in the casing.

In certain embodiments, the compositions and methods of the invention may be employed in coating of corroded or otherwise damaged tubulars. Tubulars means any type of oil field pipe, such as drill pipes, drill collars, pup joints, casings, production tubing and pipelines.

Water-dispersible epoxy resins used in accordance with the present invention have an average molecular weight of 500 to 20,000 and are prepared from a dihydric phenol and the diglycidyl ether of a dihydric phenol. To provide hydrophilicity to the epoxy resin, either chemically incorporated or external emulsifiers may be used. Suitable emulsifiers are anionic, cationic or nonionic. Both the dihydric phenol and the diglycidyl ether of a dihydric phenol may also contain other substituents such as alkyl, aryl, sulfido, sulfonyl, halo, etc.

Illustrative of suitable dihydric phenols are 2,2-bis(4-hydroxyphenyl)propane, 2,2-bis(3-bromo-4-hydroxyphenyl)propane, 2,2-bis(3-chloro-4-hydroxyphenyl)-propane, bis(4-hydroxyphenyl)methane, bis(4-hydroxyphenyl)sulfone, bis(4-hydroxyphenyl)-sulfide, resorcinol, hydroquinone, and the like. The preferred dihydric phenols are 2,2-bis(4-hydroxyphenyl)propane (bisphenol A) and bis(4-hydroxyphenyl)methane for reasons of cost and availability.

The diglycidyl ether derivatives are prepared by the reaction of a dihydric phenol with a halogen-containing epoxide or dihalohydrin in the presence of an alkaline medium. By varying the ratios of the dihydric phenol and epichlorohydrin reactants, different molecular weight products can be obtained as described in U.S. Pat. Nos. 2,582,985; 2,615,007 and 2,633,458.

For purposes of the present invention, optionally at least a portion of the diglycidyl ether of dihydric phenol component can be replaced with a diglycidyl ether of a hydrogenated dihydric phenol derivative. For example, the diglycidyl ether of dihydric phenol can have up to essentially 100 percent of its weight substituted by a diglycidyl alicyclic ether such as 2,2-bis(4-hydroxycyclohexyl)propane or bis(4-hydroxycyclohexyl)methane.

To make the epoxy resins water-dispersible, one of an anionic, cationic and nonionic external emulsifier is added to the resin and one of an anionic, cationic and nonionic emulsifier is chemically incorporated into the epoxy resin. The nonionic emulsifiers contain repeating alkylene oxide units, preferably ethylene oxide units, and have average molecular weights between 400 and 24,000.

Suitable nonionic external emulsifiers are disclosed in U.S. Pat. No. 4,073,762 and include those of the alkylaryl type such as polyoxyethylene nonyl phenyl ether or polyoxyethylene octyl phenyl ether; those of the alkyl ether type such as polyoxyethylene lauryl ether or polyoxyethylene oleyl ether; those of the alkyl ester type such as polyoxyethylene laurate, polyoxyethylene oleate or polyoxyethylene stearate; and those of the polyoxyethylene benzylated phenyl ether type. In addition, reaction products of polyethylene glycols with aromatic diglycidyl compounds such as those disclosed in U.S. Pat. No. 3,563,493 may also be used as nonionic external emulsifiers. The epoxy resin component may contain from 1 to 20%, preferably 2 to 15%, by weight of nonionic external emulsifier, based on the weight of the epoxy resin component.

Chemically incorporated nonionic emulsifiers are based on polyoxyalkylene glycols which are soluble or at least partially soluble in water. Polyoxyalkylene glycols are prepared conveniently by the condensation of an alkylene oxide with a suitable polyhydric alcohol. Illustrative of alkylene oxides are ethylene oxide and propylene oxide and mixtures thereof. Illustrative of polyhydric alcohols are aliphatic alcohols such as ethylene glycol, 1,3-propylene glycol, 1,2-propylene glycol, 1,4-butylene glycol, 1,3-butylene glycol, 1,2-butylene glycol, 1,5-pentanediol, 1,4-pentanediol, 1,3-pentanediol, 1,6-hexanediol, 1,7-heptanediol, glycerol, 1,1,1-trimethylol-propane, 1,1,1-trimethylolethane, hexane 1,2,6-triol, pentaerythritol, sorbitol, 2,2-bis(4-hydroxycyclohexyl)propane, and the like.

Preferred polyoxyalkylene glycols are those prepared by the reaction of one or more of ethylene oxide and propylene oxide with a dihydric aliphatic alcohol, e.g., ethylene glycol. Illustrative of polyoxyalkylene glycols are commercial Pluronic type products (available from BASF) which are block copolymers of ethylene oxide and propylene oxide of 5000-10,000 molecular weight, containing from 50 to 90 weight percent ethylene oxide and 10 to 50 weight percent propylene oxide.

The polyoxyalkylene glycols may be chemically incorporated through reaction of their hydroxyl groups with the epoxide rings of the epoxy resins as disclosed in U.S. Pat. No. 4,048,179. However, this method is not preferred because it reduces the number of epoxide groups available for cross-linking with the water-dispersible blocked polyisocyanate component of the present invention. Thus, it is preferred to convert the polyoxyalkylene glycol into its diglycidyl ether prior to chemically incorporating it into the epoxy resin. These diglycidyl ethers may be conveniently prepared by reacting epichlorohydrin with a selected polyoxyalkylene glycol in a molar proportion which provides substantially a diglycidyl ether reaction product. The epoxy resins may contain from 1 to 20%, preferably from 2 to 15%, by weight of chemically incorporated polyoxyalkylene glycols or their diglycidyl ethers.

A preferred epoxy resin containing chemically incorporated nonionic groups is the addition product of reactants comprising (i) 50 to 90 parts by weight of the diglycidyl ether of a dihydric phenol, (ii) 8 to 35 parts by weight of a dihydric phenol and (iii) 2 to 1, parts by weight of the diglycidyl ether of a polyoxyalkylene glycol, wherein the average molecular weight of the epoxy resin is 500 to 20,000.

Suitable compounds for preparing epoxy resins containing chemically incorporated anionic or cationic groups are those known in the art.

In accordance with the process of the present invention, the alkylphenol-blocked isocyanate and epoxy-based resin are dispersed in an aqueous medium such as water in known manner. The alkylphenol-blocked isocyanate and epoxy-based resin may be mixed prior to dispersion in water or they may be separately dispersed in water and then blended together. Although the alkylphenol-blocked isocyanate and epoxy-based resin may be mixed in any quantities, a preferred composition contains 25 to 85% by weight of the epoxy resin and 15 to 75% by weight of the alkylphenol-blocked isocyanate, all percentages being based on the total weight of the alkylphenol-blocked isocyanate and epoxy-based resin.

The type of emulsifiers used to prepare the alkylphenol-blocked isocyanate and epoxy-based resin should be compatible, i.e., anionic and cationic emulsifiers should not be mixed. However, all other combinations of anionic or cationic and nonionic chemically incorporated and external emulsifiers may be mixed.

The composition of the present invention are formed by reacting the dispersed alkylphenol-blocked isocyanate and epoxy-based resin mixture with a polyamine or a mixture of polyamines The average functionality of the amine, i.e. the number of amine nitrogen atoms per molecule, in some embodiments is between 2 and 6, in other embodiments between 2 and 4 and in still other embodiments between 2 and 3. The desired functionalities can be obtained by using mixtures of diamines and triamines. A functionality of 3.0 can be achieved either by using (1) triamines, (2) equimolar mixtures of diamines and tetramines, (3) mixtures of 1 and 2, or (4) any other suitable mixtures. These other suitable mixtures for obtaining the desired functionalities will be readily apparent to those of ordinary skill in the art.

Suitable amines are essentially hydrocarbon polyamines containing 2 to 6 amine groups which have isocyanate-reactive hydrogens according to the Zerewitinoff test, e.g., primary or secondary amino groups. The polyamines contain between 1 to 30 carbon atoms, preferably 2 to 15 carbon atoms. Polyamines containing aliphatically- or cycloaliphatically-bound amino groups are preferred, although polyamines containing aromatically-bound amino groups may also be used. The polyamines may be substituted, provided that they are not as reactive with isocyanate groups as the primary or secondary amines Examples of polyamines for use in the present invention include diethylene triamine, triethylene tetramine, tetraethylene pentamine, pentaethylene hexamine, N,N,N-tris-(2-aminoethyl)amine, N-(2-piperazinoethyl)-ethylene diamine, N,N′-bis-(2-aminoethyl)-piperazine, N,N,N′-tris-(2-amino-ethyl)-ethylene diamine, N-[N-(2-aminoethyl)-2-aminoethyl]-N′-(2-aminoethyl)-piperazine, N-(2-aminoethyl)-N′-(2-piper-azinoethyl)-ethylene diamine, N,N-bis-(2-amino-ethyl)-N-(2-piperazinoethyl)-amine, N,N-bis(2-piperazinoethyl)-amine, polyethylene amines, iminobispropylamine, guanidine, melamine, N-(2-aminoethyl)-1,3-propane diamine, 3,3′-diamino-benzidine, 2,4,6-triamino-pyrimidine, polyoxypropylene amines, tetrapropylenepentamine, tripropylenetetramine, N,N-bis-(6-aminohexyl)-amine, N,N′-bis-(3-aminopropyl)-ethylene diamine and 2,4-bis(4′-aminobenzyl)-aniline. Preferred polyamines are 1-amino-3-aminomethyl-3,5,5-trimethyl-cyclohexane (isophorone diamine or IPDA), bis-(4-aminocyclohexyl)methane, bis-(4-amino-3-methyl-cyclohexyl)-methane, 1,6-diaminohexane, ethylene diamine, diethylene triamine, triethylene tetramine, tetraethylene pentamine, pentaethylene hexamine and hydrazine hydrate.

The amount of polyamine chain extender to be used in accordance with the present invention is dependent upon the number of blocked isocyanate groups and epoxy groups in the epoxy resin. In various embodiments, the ratio of blocked isocyanate groups and epoxy groups to the primary and secondary amino groups of the polyamine is between 1.0:0.6 and 1.0:1.5, and in other embodiments between 1.0:0.8 and 1.0:1.2 on an equivalent basis. Also, undue excesses of the amine are not preferred because they may lead to products with undesirably low molecular weights. For purposes of the above ratios a primary amino group is considered to have one amino hydrogen. For example, ethylene diamine has two equivalents of amino hydrogens and diethylene triamine has three equivalents.

The reaction between the dispersed alkylphenol-blocked isocyanate and epoxy-based resin mixture and the polyamine is conducted, in some embodiments, at temperatures from 5° C. to 150° C., and in other embodiments, from 20° C. to 80° C., and, in a preferred embodiment, at ambient temperature. The polyamine may be mixed with the dispersed alkylphenol-blocked isocyanate and epoxy-based resin mixture in its pure form or it may be dissolved or dispersed in water or an organic solvent. Suitable organic solvents are those known in the art. The ratio of isocyanate groups to isocyanate-reactive groups is maintained between 1.1 to 5, preferably about 1.2 to 3 and most preferably about 1.3 to 2.0 on an equivalent basis.

After the aqueous epoxy-based resin/alkylphenol-blocked isocyanate mixture is combined with the polyamine and introduced into the borehole, the water evaporates and polyamines containing aliphatically- or cycloaliphatically-bound amino groups react with both the epoxy resin and the alkylphenol-blocked isocyanate at ambient temperature without the necessity of unblocking the blocked isocyanate groups at elevated temperatures. With currently available epoxy systems, an autocatalytic event is created by the combination of epoxy-based resin with polyamine which feeds into the exotherm. Such uncontrolled reactivity and exotherm cause initial expansion and then contraction upon cooling. This dimensional instability causes poor adhesion, cracking and leakage. In contrast, the alkylphenol-blocked isocyanate in the inventive composition will de-block upon addition of the polyamine resulting in a reduced exotherm, which improves adhesion and resilience of the reaction product.

The epoxy-based resins, used in the embodiments of the present invention, may vary and include conventional and commercially available epoxy resins, which may be used alone or in combinations of two or more. In choosing epoxy resins for compositions disclosed herein, consideration should not only be given to properties of the final product, but also to viscosity and other properties that may influence the processing of the resin composition.

Particularly suitable epoxy resins known to the skilled worker are based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known to the skilled worker include reaction products of epichlorohydrin with o-cresol and, respectively, phenol novolacs. It is also possible to use a mixture of two or more epoxy resins.

Suitable epoxy resins for the present invention are disclosed in, for example, U.S. Pat. Nos. 3,018,262; 5,405,688; 6,153,719; 6,242,083; 6,572,971; 6,632,893; 6,887,574; 7,037,958; 7,163,973; 7,655,174; 7,923,073; and 8,048,819; and in U.S. Published Patent Application No. 2007/0221890; each of which is hereby incorporated herein by reference.

In general, the choice of the epoxy resin used in the present invention depends on the application. However, diglycidyl ether of bisphenol A (DGEBA) and derivatives thereof are particularly preferred. Other epoxy resins can be selected from: bisphenol F epoxy resins, novolac epoxy resins, glycidylamine-based epoxy resins, alicyclic epoxy resins, linear aliphatic and cycloaliphatic epoxy resins, tetrabromobisphenol A epoxy resins, and combinations thereof.

In some embodiments, the concentration of the epoxy resin may be from between 1 wt. % to 99 wt. %, in other embodiments between 20 wt. % to 80 wt. %, and in certain embodiments between 30 wt. % to 60 wt. % based on the total weight of the composition.

Examples of suitable polyisocyanates to be used in accordance with the present invention are organic diisocyanates represented by the formula:

R(NCO)₂

in which R represents an organic group obtainable by removal of the isocyanate groups from an organic diisocyanate having a molecular weight of from 112 to 1,000, and in some embodiments from 140 to 400. Diisocyanates preferred for the process according to the invention are those represented by the formula indicated above in which R represents a divalent aliphatic hydrocarbon group having from 4 to 18 carbon atoms, a divalent cycloaliphatic hydrocarbon group having from 5 to 15 carbon atoms, a divalent araliphatic hydrocarbon group having from 7 to 15 carbon atoms or a divalent aromatic hydrocarbon group having 6-15 carbon atoms.

Examples of the organic diisocyanates which are particularly suitable for the invention include 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanatomethyl cyclopentane, 1-isocyanato-3-isocyanatomethyl-3,5,5-trimethylcyclohexane (isophorone diisocyanate or IPDI), bis(4-isocyanatocyclohexyl)methane, 1,3-bis(isocyanatomethyl)-cyclohexane, 1,4-bis(isocyanatomethyl)-cyclohexane, bis-(4-isocyanato-3-methyl-cyclohexyl)-methane, α,α,α′,α′-tetramethyl-1,3-xylylene diisocyanate, α,α,α′,α′-tetramethyl-1,4-xylylene diisocyanate, 1-isocyanato-1-methyl-4(3)-isocyanatomethyl cyclohexane, 2,4-hexahydrotolulene diisocyanate, 2,6-hexahydrotoluene diisocyanate, 1,3-phenylene diisocyanate, 1,4-phenylene diisocyanate, 2,4-toluene diisocyanate (2,4-TDI), 2,6-toluene diisocyanate (2,6-TDI), 2,4-diphenylmethane diisocyanate (2,4-MDI), 4,4′-diphenylmethane diisocyanate (4,4′-MDI), 1,5-diisocyanate naphthylene, 4,4′,4″-triphenylmethane diisocyanate, pentamethylene diisocyanate (PDI, bio-based) and polyphenyl polymethylene polyisocyanates obtained by phosgenating aniline/formaldehyde condensates.

Alkylphenols useful as blocking agents in the present invention include, but are not limited to, methylphenols (cresols), ethylphenols (xylenols), propylphenols, butylphenols, amylphenols, heptylphenols, octylphenols, nonylphenols, dodecylphenols and the so-called “long chain alkylphenols” (LCAPs). Particularly preferred alkylphenol-blocked isocyanates are commercially available from Covestro (DESMOCAP).

Although the compositions of the present invention are described herein in the context of oil and gas field applications, those skilled in the art will recognize their applicability to a wide variety of coatings, adhesives, castings, composites, and sealants where increased flexibility, resilience and adhesion is desired or required. The present invention is intended to encompass all such materials and applications.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant reserves the right to amend the claims during prosecution to add features as variously described in this specification, and such amendments comply with the requirements of 35 U.S.C. § 112(a), and 35 U.S.C. § 132(a).

Various aspects of the subject matter described herein are set out in the following numbered clauses:

1. An oil and gas well treatment comprising (a) preparing a composition by mixing an epoxy-based resin, an alkylphenol-blocked isocyanate, and a polyamine, (b) introducing the composition into a wellbore, (c) reacting the composition to produce a solid product, wherein the solid product reduces or prevents ingress of formation water into the oil and gas well.

2. The oil and gas well treatment according to clause 1, wherein the epoxy-based resin is selected from the group consisting of bisphenol A epoxy resins, bisphenol F epoxy resins, novolac epoxy resins, glycidylamine-based epoxy resins, alicyclic epoxy resins, linear aliphatic epoxy resins, cycloaliphatic epoxy resins, tetrabromobisphenol A epoxy resins, and combinations thereof.

3. The oil and gas well treatment according to one of clauses 1 and 2, wherein the isocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanatomethyl cyclopentane, 1-isocyanato-3-isocyanatomethyl-3,5,5-trimethylcyclohexane (isophorone diisocyanate or IPDI), bis(4-isocyanatocyclohexyl)methane, 1,3-bis(isocyanatomethyl)-cyclohexane, 1,4-bis(isocyanatomethyl)-cyclohexane, bis-(4-isocyanato-3-methyl-cyclohexyl)-methane, α,α,α′,α′-tetramethyl-1,3-xylylene diisocyanate, α,α,α′,α′-tetramethyl-1,4-xylylene diisocyanate, 1-isocyanato-1-methyl-4(3)-isocyanatomethyl cyclohexane, 2,4-hexahydrotolulene diisocyanate, 2,6-hexahydrotoluene diisocyanate, 1,3-phenylene diisocyanate, 1,4-phenylene diisocyanate, 2,4-toluene diisocyanate (2,4-TDI), 2,6-toluene diisocyanate (2,6-TDI), 2,4-diphenylmethane diisocyanate (2,4-MDI), 4,4′-diphenylmethane diisocyanate (4,4′-MDI), 1,5-diisocyanate naphthylene, 4,4′,4″-triphenylmethane diisocyanate, pentamethylene diisocyanate (PDI, bio-based), and combinations thereof.

4. The oil and gas well treatment according to one of clauses 1 to 3, wherein the alkylphenol is selected from the group consisting of methylphenols (cresols), ethylphenols (xylenols), propylphenols, butylphenols, amylphenols, heptylphenols, octylphenols, nonylphenols, dodecylphenols, long chain alkylphenols (LCAPs), and combinations thereof.

5. The oil and gas well treatment according to one of clauses 1 to 4, wherein the polyamine is selected from the group consisting of 1,6-diaminohexane, 1-amino-3-aminomethyl-3,5,5-trimethyl-cyclohexane (isophorone diamine or IPDA), 2,4,6-triamino-pyrimidine, 2,4-bis(4′-aminobenzyl)-aniline, 3,3′-diamino-benzidine, bis-(4-amino-3-methyl-cyclohexyl)-methane, bis-(4-aminocyclohexyl)methane, diethylene triamine, ethylene diamine, guanidine, hydrazine hydrate, iminobispropylamine, melamine, N-(2-aminoethyl)-1,3-propane diamine, N-(2-aminoethyl)-N′-(2-piper-azinoethyl)-ethylene diamine, N-(2-piperazinoethyl)-ethylene diamine, N,N,N-tris-(2-aminoethyl)amine, N,N,N′-tris-(2-amino-ethyl)-ethylene diamine, N,N-bis-(2-amino-ethyl)-N-(2-piperazinoethyl)-amine, N,N′-bis-(2-aminoethyl)-piperazine, N,N-bis(2-piperazinoethyl)-amine, N,N′-bis-(3-aminopropyl)-ethylene diamine, N,N-bis-(6-aminohexyl)-amine, N-[N-(2-aminoethyl)-2-aminoethyl]-N′-(2-aminoethyl)-piperazine, pentaethylene hexamine, polyethylene amines, polyoxypropylene amines, tetraethylene pentamine, tetrapropylenepentamine, triethylene tetramine, tripropylenetetramine, and combinations thereof.

6. The oil and gas well treatment according to one of clauses 1 to 5, wherein the composition exhibits improved adhesion and resiliency compared to epoxy-based resins.

7. The oil and gas well treatment according to one of clauses 1 to 6, wherein the epoxy-based resin is water-dispersible.

8. The oil and gas well treatment according to one of clauses 1 to 7, wherein the epoxy-based resin includes an emulsifier.

9. The oil and gas well treatment according to one of clauses 1 to 8, wherein the solid product comprises a well plug.

10. The oil and gas well treatment according to one of clauses 1 to 9, wherein the treatment is selected from the group consisting of plug and abandonment, reduction or prevention of water flooding, sand consolidation, bottom water and edge water control, drilling fluid loss control, drilling wellbore strengthening, horizontal drilling, high angle drilling wellbore treatment in bend areas of 60° or greater inclination, stacked pay zone plugging through straddle packer application, small fault sealing prior to acidizing or fracturing, injection well treatment for shut-off of weak or fractured layers, leaking annulus repair; deep well channel repair, and coating of corroded or otherwise damaged tubulars.

11. An oil and gas well plug comprising an epoxy-based resin, an alkylphenol-blocked isocyanate, and a polyamine.

12. The oil and gas well plug according to clause 11, wherein the epoxy-based resin is selected from the group consisting of bisphenol A epoxy resins, bisphenol F epoxy resins, novolac epoxy resins, glycidylamine-based epoxy resins, alicyclic epoxy resins, linear aliphatic epoxy resins, cycloaliphatic epoxy resins, tetrabromobisphenol A epoxy resins, and combinations thereof.

13. The oil and gas well plug according to one of clauses 11 and 12, wherein the isocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanatomethyl cyclopentane, 1-isocyanato-3-isocyanatomethyl-3,5,5-trimethylcyclohexane (isophorone diisocyanate or IPDI), bis(4-isocyanatocyclohexyl)methane, 1,3-bis(isocyanatomethyl)-cyclohexane, 1,4-bis(isocyanatomethyl)-cyclohexane, bis-(4-isocyanato-3-methyl-cyclohexyl)-methane, α,α,α′,α′-tetramethyl-1,3-xylylene diisocyanate, α,α,α′,α′-tetramethyl-1,4-xylylene diisocyanate, 1-isocyanato-1-methyl-4(3)-isocyanatomethyl cyclohexane, 2,4-hexahydrotolulene diisocyanate, 2,6-hexahydrotoluene diisocyanate, 1,3-phenylene diisocyanate, 1,4-phenylene diisocyanate, 2,4-toluene diisocyanate (2,4-TDI), 2,6-toluene diisocyanate (2,6-TDI), 2,4-diphenylmethane diisocyanate (2,4-MDI), 4,4′-diphenylmethane diisocyanate (4,4′-MDI), 1,5-diisocyanate naphthylene, 4,4′,4″-triphenylmethane diisocyanate, pentamethylene diisocyanate (PDI, bio-based), and combinations thereof.

14. The oil and gas well plug according to one of clauses 11 to 13, wherein the alkylphenol is selected from the group consisting of methylphenols (cresols), ethylphenols (xylenols), propylphenols, butylphenols, amylphenols, heptylphenols, octylphenols, nonylphenols, dodecylphenols, long chain alkylphenols (LCAPs), and combinations thereof.

15. The oil and gas well plug according to one of clauses 11 to 14, wherein the polyamine is selected from the group consisting of 1,6-diaminohexane, 1-amino-3-aminomethyl-3,5,5-trimethyl-cyclohexane (isophorone diamine or IPDA), 2,4,6-triamino-pyrimidine, 2,4-bis(4′-aminobenzyl)-aniline, 3,3′-diamino-benzidine, bis-(4-amino-3-methyl-cyclohexyl)-methane, bis-(4-aminocyclohexyl)methane, diethylene triamine, ethylene diamine, guanidine, hydrazine hydrate, iminobispropylamine, melamine, N-(2-aminoethyl)-1,3-propane diamine, N-(2-aminoethyl)-N′-(2-piper-azinoethyl)-ethylene diamine, N-(2-piperazinoethyl)-ethylene diamine, N,N,N-tris-(2-aminoethyl)amine, N,N,N′-tris-(2-amino-ethyl)-ethylene diamine, N,N-bis-(2-amino-ethyl)-N-(2-piperazinoethyl)-amine, N,N′-bis-(2-aminoethyl)-piperazine, N,N-bis(2-piperazinoethyl)-amine, N,N′-bis-(3-aminopropyl)-ethylene diamine, N,N-bis-(6-aminohexyl)-amine, N-[N-(2-aminoethyl)-2-aminoethyl]-N′-(2-aminoethyl)-piperazine, pentaethylene hexamine, polyethylene amines, polyoxypropylene amines, tetraethylene pentamine, tetrapropylenepentamine, triethylene tetramine, tripropylenetetramine, and combinations thereof.

16. The oil and gas well plug according to one of clauses 11 to 15, wherein the plug exhibits improved adhesion and resiliency compared to epoxy-based resins.

17. The oil and gas well plug according to one of clauses 11 to 16, wherein the epoxy-based resin is water-dispersible.

18. The oil and gas well plug according to one of clauses 11 to 17, wherein the epoxy-based resin includes an emulsifier.

19. A method of treating an oil and gas well within an underground formation, comprising (a) preparing a composition by mixing an epoxy-based resin with an alkylphenol-blocked isocyanate and a polyamine, (b) introducing the composition into the well, (c) forcing the composition into pores of the formation and (d) reacting the composition to form a solid product, wherein the solid product seals existing perforations and associated fractures of the formation to reduce or prevent the ingress of water into at least a portion of a wellbore or an oil and gas well within the formation.

20. The method according to clause 19, wherein the epoxy-based resin is selected from the group consisting of bisphenol A epoxy resins, bisphenol F epoxy resins, novolac epoxy resins, glycidylamine-based epoxy resins, alicyclic epoxy resins, linear aliphatic epoxy resins, cycloaliphatic epoxy resins, tetrabromobisphenol A epoxy resins, and combinations thereof.

21. The method according to one of clauses 19 and 20, wherein the isocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanatomethyl cyclopentane, 1-isocyanato-3-isocyanatomethyl-3,5,5-trimethylcyclohexane (isophorone diisocyanate or IPDI), bis(4-isocyanatocyclohexyl)methane, 1,3-bis(isocyanatomethyl)-cyclohexane, 1,4-bis(isocyanatomethyl)-cyclohexane, bis-(4-isocyanato-3-methyl-cyclohexyl)-methane, α,α,α′,α′-tetramethyl-1,3-xylylene diisocyanate, α,α,α′,α′-tetramethyl-1,4-xylylene diisocyanate, 1-isocyanato-1-methyl-4(3)-isocyanatomethyl cyclohexane, 2,4-hexahydrotolulene diisocyanate, 2,6-hexahydrotoluene diisocyanate, 1,3-phenylene diisocyanate, 1,4-phenylene diisocyanate, 2,4-toluene diisocyanate (2,4-TDI), 2,6-toluene diisocyanate (2,6-TDI), 2,4-diphenylmethane diisocyanate (2,4-MDI), 4,4′-diphenylmethane diisocyanate (4,4′-MDI), 1,5-diisocyanate naphthylene, 4,4′,4″-triphenylmethane diisocyanate, pentamethylene diisocyanate (PDI, bio-based), and combinations thereof.

22. The method according to one of clauses 19 to 21, wherein the alkylphenol is selected from the group consisting of methylphenols (cresols), ethylphenols (xylenols), propylphenols, butylphenols, amylphenols, heptylphenols, octylphenols, nonylphenols, dodecylphenols, long chain alkylphenols (LCAPs), and combinations thereof.

23. The method according to one of clauses 19 to 22, wherein the polyamine is selected from the group consisting of 1,6-diaminohexane, 1-amino-3-aminomethyl-3,5,5-trimethyl-cyclohexane (isophorone diamine or IPDA), 2,4,6-triamino-pyrimidine, 2,4-bis(4′-aminobenzyl)-aniline, 3,3′-diamino-benzidine, bis-(4-amino-3-methyl-cyclohexyl)-methane, bis-(4-aminocyclohexyl)methane, diethylene triamine, ethylene diamine, guanidine, hydrazine hydrate, iminobispropylamine, melamine, N-(2-aminoethyl)-1,3-propane diamine, N-(2-aminoethyl)-N′-(2-piper-azinoethyl)-ethylene diamine, N-(2-piperazinoethyl)-ethylene diamine, N,N,N-tris-(2-aminoethyl)amine, N,N,N′-tris-(2-amino-ethyl)-ethylene diamine, N,N-bis-(2-amino-ethyl)-N-(2-piperazinoethyl)-amine, N,N′-bis-(2-aminoethyl)-piperazine, N,N-bis(2-piperazinoethyl)-amine, N,N′-bis-(3-aminopropyl)-ethylene diamine, N,N-bis-(6-aminohexyl)-amine, N-[N-(2-aminoethyl)-2-aminoethyl]-N′-(2-aminoethyl)-piperazine, pentaethylene hexamine, polyethylene amines, polyoxypropylene amines, tetraethylene pentamine, tetrapropylenepentamine, triethylene tetramine, tripropylenetetramine, and combinations thereof.

24. The method according to one of clauses 19 to 23, wherein the composition exhibits improved adhesion and resiliency compared to epoxy-based resins.

25. The method according to one of clauses 19 to 24, wherein the treatment is selected from the group consisting of plug and abandonment, reduction or prevention of water flooding, sand consolidation, bottom water and edge water control, drilling fluid loss control, drilling wellbore strengthening, horizontal drilling, high angle drilling wellbore treatment in bend areas of 60° or greater inclination, stacked pay zone plugging through straddle packer application, small fault sealing prior to acidizing or fracturing, injection well treatment for shut-off of weak or fractured layers, leaking annulus repair; deep well channel repair, and coating of corroded or otherwise damaged tubulars.

26. The method according to one of clauses 19 to 25, wherein the epoxy-based resin is water-dispersible.

27. The method according to one of clauses 19 to 26 further including adding an emulsifier to the epoxy-based resin.

28. An oil and gas well containing a composition comprising an epoxy-based resin, an alkylphenol-blocked isocyanate, and a polyamine, wherein the composition solidifies within the oil and gas well to partially or completely prevent water ingress.

29. The oil and gas well according to clause 28, wherein the epoxy-based resin is selected from the group consisting of bisphenol A epoxy resins, bisphenol F epoxy resins, novolac epoxy resins, glycidylamine-based epoxy resins, alicyclic epoxy resins, linear aliphatic epoxy resins, cycloaliphatic epoxy resins, tetrabromobisphenol A epoxy resins, and combinations thereof.

30. The oil and gas well according to one of clauses 28 and 29, wherein the isocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanatomethyl cyclopentane, 1-isocyanato-3-isocyanatomethyl-3,5,5-trimethylcyclohexane (isophorone diisocyanate or IPDI), bis(4-isocyanatocyclohexyl)methane, 1,3-bis(isocyanatomethyl)-cyclohexane, 1,4-bis(isocyanatomethyl)-cyclohexane, bis-(4-isocyanato-3-methyl-cyclohexyl)-methane, α,α,α′,α′-tetramethyl-1,3-xylylene diisocyanate, α,α,α′,α′-tetramethyl-1,4-xylylene diisocyanate, 1-isocyanato-1-methyl-4(3)-isocyanatomethyl cyclohexane, 2,4-hexahydrotolulene diisocyanate, 2,6-hexahydrotoluene diisocyanate, 1,3-phenylene diisocyanate, 1,4-phenylene diisocyanate, 2,4-toluene diisocyanate (2,4-TDI), 2,6-toluene diisocyanate (2,6-TDI), 2,4-diphenylmethane diisocyanate (2,4-MDI), 4,4′-diphenylmethane diisocyanate (4,4′-MDI), 1,5-diisocyanate naphthylene, 4,4′,4″-triphenylmethane diisocyanate, pentamethylene diisocyanate (PDI, bio-based), and combinations thereof.

31. The oil and gas well according to one of clauses 28 to 30, wherein the alkylphenol is selected from the group consisting of methylphenols (cresols), ethylphenols (xylenols), propylphenols, butylphenols, amylphenols, heptylphenols, octylphenols, nonylphenols, dodecylphenols, long chain alkylphenols (LCAPs), and combinations thereof.

32. The oil and gas well according to one of clauses 28 to 31, wherein the polyamine is selected from the group consisting of 1,6-diaminohexane, 1-amino-3-aminomethyl-3,5,5-trimethyl-cyclohexane (isophorone diamine or IPDA), 2,4,6-triamino-pyrimidine, 2,4-bis(4′-aminobenzyl)-aniline, 3,3′-diamino-benzidine, bis-(4-amino-3-methyl-cyclohexyl)-methane, bis-(4-aminocyclohexyl)methane, diethylene triamine, ethylene diamine, guanidine, hydrazine hydrate, iminobispropylamine, melamine, N-(2-aminoethyl)-1,3-propane diamine, N-(2-aminoethyl)-N′-(2-piper-azinoethyl)-ethylene diamine, N-(2-piperazinoethyl)-ethylene diamine, N,N,N-tris-(2-aminoethyl)amine, N,N,N′-tris-(2-amino-ethyl)-ethylene diamine, N,N-bis-(2-amino-ethyl)-N-(2-piperazinoethyl)-amine, N,N′-bis-(2-aminoethyl)-piperazine, N,N-bis(2-piperazinoethyl)-amine, N,N′-bis-(3-aminopropyl)-ethylene diamine, N,N-bis-(6-aminohexyl)-amine, N-[N-(2-aminoethyl)-2-aminoethyl]-N′-(2-aminoethyl)-piperazine, pentaethylene hexamine, polyethylene amines, polyoxypropylene amines, tetraethylene pentamine, tetrapropylenepentamine, triethylene tetramine, tripropylenetetramine, and combinations thereof.

33. The oil and gas well according to one of clauses 28 to 32, wherein the composition exhibits improved adhesion and resiliency compared to epoxy-based resins.

34. The oil and gas well according to one of clauses 28 to 33, wherein the epoxy-based resin is water-dispersible.

35. The oil and gas well according to one of clauses 28 to 34, wherein the epoxy-based resin includes an emulsifier.

What is claimed is:

1. An oil and gas well treatment comprising:
(a) preparing a composition by mixing an epoxy-based resin, an alkylphenol-blocked isocyanate, and a polyamine;
(b) introducing the composition into a wellbore;
(c) reacting the composition to produce a solid product,
wherein the solid product reduces or prevents ingress of formation water into the oil and gas well.

2. The oil and gas well treatment according to claim 1, wherein the epoxy-based resin is selected from the group consisting of bisphenol A epoxy resins, bisphenol F epoxy resins, novolac epoxy resins, glycidylamine-based epoxy resins, alicyclic epoxy resins, linear aliphatic epoxy resins, cycloaliphatic epoxy resins, tetrabromobisphenol A epoxy resins, and combinations thereof.

3. The oil and gas well treatment according to claim 1, wherein the isocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanatomethyl cyclopentane, 1-isocyanato-3-isocyanatomethyl-3,5,5-trimethylcyclohexane (isophorone diisocyanate or IPDI), bis(4-isocyanatocyclohexyl)methane, 1,3-bis(isocyanatomethyl)-cyclohexane, 1,4-bis(isocyanatomethyl)-cyclohexane, bis-(4-isocyanato-3-methyl-cyclohexyl)-methane, α,α,α′,α′-tetramethyl-1,3-xylylene diisocyanate, α,α,α′,α′-tetramethyl-1,4-xylylene diisocyanate, 1-isocyanato-1-methyl-4(3)-isocyanatomethyl cyclohexane, 2,4-hexahydrotolulene diisocyanate, 2,6-hexahydrotoluene diisocyanate, 1,3-phenylene diisocyanate, 1,4-phenylene diisocyanate, 2,4-toluene diisocyanate (2,4-TDI), 2,6-toluene diisocyanate (2,6-TDI), 2,4-diphenylmethane diisocyanate (2,4-MDI), 4,4′-diphenylmethane diisocyanate (4,4′-MDI), 1,5-diisocyanate naphthylene, 4,4′,4″-triphenylmethane diisocyanate, pentamethylene diisocyanate (PDI, bio-based), and combinations thereof.

4. The oil and gas well treatment according to claim 1, wherein the alkylphenol is selected from the group consisting of methylphenols (cresols), ethylphenols (xylenols), propylphenols, butylphenols, amylphenols, heptylphenols, octylphenols, nonylphenols, dodecylphenols, long chain alkylphenols (LCAPs), and combinations thereof.

5. The oil and gas well treatment according to claim 1, wherein the polyamine is selected from the group consisting of 1,6-diaminohexane, 1-amino-3-aminomethyl-3,5,5-trimethyl-cyclohexane (isophorone diamine or IPDA), 2,4,6-triamino-pyrimidine, 2,4-bis(4′-aminobenzyl)-aniline, 3,3′-diamino-benzidine, bis-(4-amino-3-methyl-cyclohexyl)-methane, bis-(4-aminocyclohexyl)methane, diethylene triamine, ethylene diamine, guanidine, hydrazine hydrate, iminobispropylamine, melamine, N-(2-aminoethyl)-1,3-propane diamine, N-(2-aminoethyl)-N′-(2-piper-azinoethyl)-ethylene diamine, N-(2-piperazinoethyl)-ethylene diamine, N,N,N-tris-(2-aminoethyl)amine, N,N,N′-tris-(2-amino-ethyl)-ethylene diamine, N,N-bis-(2-amino-ethyl)-N-(2-piperazinoethyl)-amine, N,N′-bis-(2-aminoethyl)-piperazine, N,N-bis(2-piperazinoethyl)-amine, N,N′-bis-(3-aminopropyl)-ethylene diamine, N,N-bis-(6-aminohexyl)-amine, N-[N-(2-aminoethyl)-2-aminoethyl]-N′-(2-aminoethyl)-piperazine, pentaethylene hexamine, polyethylene amines, polyoxypropylene amines, tetraethylene pentamine, tetrapropylenepentamine, triethylene tetramine, tripropylenetetramine, and combinations thereof.

6. The oil and gas well treatment according to claim 1, wherein the composition exhibits improved adhesion and resiliency compared to epoxy-based resins.

7. The oil and gas well treatment according to claim 1, wherein the epoxy-based resin is water-dispersible.

8. The oil and gas well treatment according to claim 1, wherein the epoxy-based resin includes an emulsifier.

9. The oil and gas well treatment according to claim 1, wherein the solid product comprises a well plug.

10. The oil and gas well treatment according to claim 1, wherein the treatment is selected from the group consisting of plug and abandonment, reduction or prevention of water flooding, sand consolidation, bottom water and edge water control, drilling fluid loss control, drilling wellbore strengthening, horizontal drilling, high angle drilling wellbore treatment in bend areas of 60° or greater inclination, stacked pay zone plugging through straddle packer application, small fault sealing prior to acidizing or fracturing, injection well treatment for shut-off of weak or fractured layers, leaking annulus repair; deep well channel repair, and coating of corroded or otherwise damaged tubulars.

11. An oil and gas well plug comprising:
an epoxy-based resin;
an alkylphenol-blocked isocyanate; and
a polyamine.

12. The oil and gas well plug according to claim 11, wherein the epoxy-based resin is selected from the group consisting of bisphenol A epoxy resins, bisphenol F epoxy resins, novolac epoxy resins, glycidylamine-based epoxy resins, alicyclic epoxy resins, linear aliphatic epoxy resins, cycloaliphatic epoxy resins, tetrabromobisphenol A epoxy resins, and combinations thereof.

13. The oil and gas well plug according to claim 11, wherein the isocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanatomethyl cyclopentane, 1-isocyanato-3-isocyanatomethyl-3,5,5-trimethylcyclohexane (isophorone diisocyanate or IPDI), bis(4-isocyanatocyclohexyl)methane, 1,3-bis(isocyanatomethyl)-cyclohexane, 1,4-bis(isocyanatomethyl)-cyclohexane, bis-(4-isocyanato-3-methyl-cyclohexyl)-methane, α,α,α′,α′-tetramethyl-1,3-xylylene diisocyanate, α,α,α′,α′-tetramethyl-1,4-xylylene diisocyanate, 1-isocyanato-1-methyl-4(3)-isocyanatomethyl cyclohexane, 2,4-hexahydrotolulene diisocyanate, 2,6-hexahydrotoluene diisocyanate, 1,3-phenylene diisocyanate, 1,4-phenylene diisocyanate, 2,4-toluene diisocyanate (2,4-TDI), 2,6-toluene diisocyanate (2,6-TDI), 2,4-diphenylmethane diisocyanate (2,4-MDI), 4,4′-diphenylmethane diisocyanate (4,4′-MDI), 1,5-diisocyanate naphthylene, 4,4′,4″-triphenylmethane diisocyanate, pentamethylene diisocyanate (PDI, bio-based), and combinations thereof.

14. The oil and gas well plug according to claim 11, wherein the alkylphenol is selected from the group consisting of methylphenols (cresols), ethylphenols (xylenols), propylphenols, butylphenols, amylphenols, heptylphenols, octylphenols, nonylphenols, dodecylphenols, long chain alkylphenols (LCAPs), and combinations thereof.

15. The oil and gas well plug according to claim 11, wherein the polyamine is selected from the group consisting of 1,6-diaminohexane, 1-amino-3-aminomethyl-3,5,5-trimethyl-cyclohexane (isophorone diamine or IPDA), 2,4,6-triamino-pyrimidine, 2,4-bis(4′-aminobenzyl)-aniline, 3,3′-diamino-benzidine, bis-(4-amino-3-methyl-cyclohexyl)-methane, bis-(4-aminocyclohexyl)methane, diethylene triamine, ethylene diamine, guanidine, hydrazine hydrate, iminobispropylamine, melamine, N-(2-aminoethyl)-1,3-propane diamine, N-(2-aminoethyl)-N′-(2-piper-azinoethyl)-ethylene diamine, N-(2-piperazinoethyl)-ethylene diamine, N,N,N-tris-(2-aminoethyl)amine, N,N,N′-tris-(2-amino-ethyl)-ethylene diamine, N,N-bis-(2-amino-ethyl)-N-(2-piperazinoethyl)-amine, N,N′-bis-(2-aminoethyl)-piperazine, N,N-bis(2-piperazinoethyl)-amine, N,N′-bis-(3-aminopropyl)-ethylene diamine, N,N-bis-(6-aminohexyl)-amine, N-[N-(2-aminoethyl)-2-aminoethyl]-N′-(2-aminoethyl)-piperazine, pentaethylene hexamine, polyethylene amines, polyoxypropylene amines, tetraethylene pentamine, tetrapropylenepentamine, triethylene tetramine, tripropylenetetramine, and combinations thereof.

16. The oil and gas well plug according to claim 11, wherein the plug exhibits improved adhesion and resiliency compared to epoxy-based resins.

17. The oil and gas well plug according to claim 11, wherein the epoxy-based resin is water-dispersible.

18. The oil and gas well plug according to claim 11, wherein the epoxy-based resin includes an emulsifier.

19. A method of treating an oil and gas well within an underground formation, comprising:
(a) preparing a composition by mixing an epoxy-based resin with an alkylphenol-blocked isocyanate and a polyamine;
(b) introducing the composition into the well;
(c) forcing the composition into pores of the formation; and
(d) reacting the composition to form a solid product,
wherein the solid product seals existing perforations and associated fractures of the formation to reduce or prevent the ingress of water into at least a portion of a wellbore or an oil and gas well within the formation.

20. The method according to claim 19, wherein the epoxy-based resin is selected from the group consisting of bisphenol A epoxy resins, bisphenol F epoxy resins, novolac epoxy resins, glycidylamine-based epoxy resins, alicyclic epoxy resins, linear aliphatic epoxy resins, cycloaliphatic epoxy resins, tetrabromobisphenol A epoxy resins, and combinations thereof.

21. The method according to claim 19, wherein the isocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanatomethyl cyclopentane, 1-isocyanato-3-isocyanatomethyl-3,5,5-trimethylcyclohexane (isophorone diisocyanate or IPDI), bis(4-isocyanatocyclohexyl)methane, 1,3-bis(isocyanatomethyl)-cyclohexane, 1,4-bis(isocyanatomethyl)-cyclohexane, bis-(4-isocyanato-3-methyl-cyclohexyl)-methane, α,α,α′,α′-tetramethyl-1,3-xylylene diisocyanate, α,α,α′,α′-tetramethyl-1,4-xylylene diisocyanate, 1-isocyanato-1-methyl-4(3)-isocyanatomethyl cyclohexane, 2,4-hexahydrotolulene diisocyanate, 2,6-hexahydrotoluene diisocyanate, 1,3-phenylene diisocyanate, 1,4-phenylene diisocyanate, 2,4-toluene diisocyanate (2,4-TDI), 2,6-toluene diisocyanate (2,6-TDI), 2,4-diphenylmethane diisocyanate (2,4-MDI), 4,4′-diphenylmethane diisocyanate (4,4′-MDI), 1,5-diisocyanate naphthylene, 4,4′,4″-triphenylmethane diisocyanate, pentamethylene diisocyanate (PDI, bio-based), and combinations thereof.

22. The method according to claim 19, wherein the alkylphenol is selected from the group consisting of methylphenols (cresols), ethylphenols (xylenols), propylphenols, butylphenols, amylphenols, heptylphenols, octylphenols, nonylphenols, dodecylphenols, long chain alkylphenols (LCAPs), and combinations thereof.

23. The method according to claim 19, wherein the polyamine is selected from the group consisting of 1,6-diaminohexane, 1-amino-3-aminomethyl-3,5,5-trimethyl-cyclohexane (isophorone diamine or IPDA), 2,4,6-triamino-pyrimidine, 2,4-bis(4′-aminobenzyl)-aniline, 3,3′-diamino-benzidine, bis-(4-amino-3-methyl-cyclohexyl)-methane, bis-(4-aminocyclohexyl)methane, diethylene triamine, ethylene diamine, guanidine, hydrazine hydrate, iminobispropylamine, melamine, N-(2-aminoethyl)-1,3-propane diamine, N-(2-aminoethyl)-N′-(2-piper-azinoethyl)-ethylene diamine, N-(2-piperazinoethyl)-ethylene diamine, N,N,N-tris-(2-aminoethyl)amine, N,N,N′-tris-(2-amino-ethyl)-ethylene diamine, N,N-bis-(2-amino-ethyl)-N-(2-piperazinoethyl)-amine, N,N′-bis-(2-aminoethyl)-piperazine, N,N-bis(2-piperazinoethyl)-amine, N,N′-bis-(3-aminopropyl)-ethylene diamine, N,N-bis-(6-aminohexyl)-amine, N-[N-(2-aminoethyl)-2-aminoethyl]-N′-(2-aminoethyl)-piperazine, pentaethylene hexamine, polyethylene amines, polyoxypropylene amines, tetraethylene pentamine, tetrapropylenepentamine, triethylene tetramine, tripropylenetetramine, and combinations thereof.

24. The method according to claim 19, wherein the composition exhibits improved adhesion and resiliency compared to epoxy-based resins.

25. The method according to claim 19, wherein the treatment is selected from the group consisting of plug and abandonment, reduction or prevention of water flooding, sand consolidation, bottom water and edge water control, drilling fluid loss control, drilling wellbore strengthening, horizontal drilling, high angle drilling wellbore treatment in bend areas of 60° or greater inclination, stacked pay zone plugging through straddle packer application, small fault sealing prior to acidizing or fracturing, injection well treatment for shut-off of weak or fractured layers, leaking annulus repair; deep well channel repair, and coating of corroded or otherwise damaged tubulars.

26. The method according to claim 19, wherein the epoxy-based resin is water-dispersible.

27. The method according to claim 19 further including adding an emulsifier to the epoxy-based resin.

28. An oil and gas well containing a composition comprising:
an epoxy-based resin;
an alkylphenol-blocked isocyanate; and
a polyamine,
wherein the composition solidifies within the oil and gas well to partially or completely prevent water ingress.

29. The oil and gas well according to claim 28, wherein the epoxy-based resin is selected from the group consisting of bisphenol A epoxy resins, bisphenol F epoxy resins, novolac epoxy resins, glycidylamine-based epoxy resins, alicyclic epoxy resins, linear aliphatic epoxy resins, cycloaliphatic epoxy resins, tetrabromobisphenol A epoxy resins, and combinations thereof.

30. The oil and gas well according to claim 28, wherein the isocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3-diisocyanate, cyclohexane-1,4-diisocyanate, 1-isocyanato-2-isocyanatomethyl cyclopentane, 1-isocyanato-3-isocyanatomethyl-3,5,5-trimethylcyclohexane (isophorone diisocyanate or IPDI), bis(4-isocyanatocyclohexyl)methane, 1,3-bis(isocyanatomethyl)-cyclohexane, 1,4-bis(isocyanatomethyl)-cyclohexane, bis-(4-isocyanato-3-methyl-cyclohexyl)-methane, α,α,α′,α′-tetramethyl-1,3-xylylene diisocyanate, α,α,α′,α′-tetramethyl-1,4-xylylene diisocyanate, 1-isocyanato-1-methyl-4(3)-isocyanatomethyl cyclohexane, 2,4-hexahydrotolulene diisocyanate, 2,6-hexahydrotoluene diisocyanate, 1,3-phenylene diisocyanate, 1,4-phenylene diisocyanate, 2,4-toluene diisocyanate (2,4-TDI), 2,6-toluene diisocyanate (2,6-TDI), 2,4-diphenylmethane diisocyanate (2,4-MDI), 4,4′-diphenylmethane diisocyanate (4,4′-MDI), 1,5-diisocyanate naphthylene, 4,4′,4″-triphenylmethane diisocyanate, pentamethylene diisocyanate (PDI, bio-based), and combinations thereof.

31. The oil and gas well according to claim 28, wherein the alkylphenol is selected from the group consisting of methylphenols (cresols), ethylphenols (xylenols), propylphenols, butylphenols, amylphenols, heptylphenols, octylphenols, nonylphenols, dodecylphenols, long chain alkylphenols (LCAPs), and combinations thereof.

32. The oil and gas well according to claim 28, wherein the polyamine is selected from the group consisting of 1,6-diaminohexane, 1-amino-3-aminomethyl-3,5,5-trimethyl-cyclohexane (isophorone diamine or IPDA), 2,4,6-triamino-pyrimidine, 2,4-bis(4′-aminobenzyl)-aniline, 3,3′-diamino-benzidine, bis-(4-amino-3-methyl-cyclohexyl)-methane, bis-(4-aminocyclohexyl)methane, diethylene triamine, ethylene diamine, guanidine, hydrazine hydrate, iminobispropylamine, melamine, N-(2-aminoethyl)-1,3-propane diamine, N-(2-aminoethyl)-N′-(2-piper-azinoethyl)-ethylene diamine, N-(2-piperazinoethyl)-ethylene diamine, N,N,N-tris-(2-aminoethyl)amine, N,N,N′-tris-(2-amino-ethyl)-ethylene diamine, N,N-bis-(2-amino-ethyl)-N-(2-piperazinoethyl)-amine, N,N′-bis-(2-aminoethyl)-piperazine, N,N-bis(2-piperazinoethyl)-amine, N,N′-bis-(3-aminopropyl)-ethylene diamine, N,N-bis-(6-aminohexyl)-amine, N-[N-(2-aminoethyl)-2-aminoethyl]-N′-(2-aminoethyl)-piperazine, pentaethylene hexamine, polyethylene amines, polyoxypropylene amines, tetraethylene pentamine, tetrapropylenepentamine, triethylene tetramine, tripropylenetetramine, and combinations thereof.

33. The oil and gas well according to claim 28, wherein the composition exhibits improved adhesion and resiliency compared to epoxy-based resins.

34. The oil and gas well according to claim 28, wherein the epoxy-based resin is water-dispersible.

35. The oil and gas well according to claim 28, wherein the epoxy-based resin includes an emulsifier.
